(19) United States
(12) Patent Application Publication
(10) Pub. No.: US 2022/0237498 A1
(43) Pub. Date: Jul. 28, 2022

(54) SYSTEM AND METHOD FOR QUANTUM DATA BUFFERING

(71) Applicant: John A. Bruce, Madison, AL (US)

(72) Inventor: John A. Bruce, Madison, AL (US)

(21) Appl. No.: 17/612,844

(22) PCT Filed: Sep. 22, 2020
(86) PCT No.: PCT/US2020/051982

§ 371 Date: Nov. 19, 2021

(51) Int. Cl. G06N 10/80; G06F 13/20

(52) U.S. Cl. CPC G06N 10/80; G06F 13/20

(57) ABSTRACT

A quantum data buffering system includes a data processor connected to a photon path quantum data buffer, a quantum mechanical elements source, a double slit filter, a non-linear optical crystal, a spontaneous parametric down converter and a Glan-Thompson prism. An output channel includes a data encoding sensor, qubits storage and single photon records storage. An input channel, includes a data decoding sensor and single photon records storage with path information.

### CROSS-REFERENCE TO RELATED APPLICATION

This application claims priority in International Application No. PCT/US2020/051982, filed Sep. 22, 2020, which claims priority in U.S. Provisional Patent Application No. 62/907,645 for Method for Quantum Data Buffering, filed Sep. 29, 2019, which is incorporated herein by reference.

### BACKGROUND OF THE INVENTION

### 1. Field of the Invention

The present invention relates generally to quantum mechanics for data state buffering, and particularly to a system and method for quantum data buffering.

### 2. Description of the Related Art

Data state is currently transferred using methods like radio signals, electrical signals, and light signals. These methods have limitations of interference, latency, distance, and line of sight. Data transfer using quantum entanglement has been demonstrated to overcome these transfer limits.

Currently there are no practical methods that indefinitely preserve the state of data in superposition to allow the use of the quantum entanglement to transfer data instantaneously without regard to interference, latency, distance, and line of sight.

Heretofore there has not been available a system or method for quantum data buffering with the advantages and features of the present invention.

Additional background information for the present invention can be found at https://laser.physics.sunysb.edu/_amarch/eraser/index.html, the contents of which are incorporated by reference.

### BRIEF SUMMARY OF THE INVENTION

The present invention generally provides a system and method for quantum data buffering that encodes data in superposition and then later by control of the measurement and observation sets the state of that data in superposition to a defined state. A preferred embodiment of this method has an external interface with an output channel of data in superposition and an input channel for setting the state of the data in superposition. A preferred embodiment of this method internally encodes data to be transmitted in superposition state. Measurement in combination with observation of the data in superposition is delayed to preserve the data's undetermined state. Transmission of information can then be achieved by sending the desired state of the data in superposition through the input data channel, which decodes the data in superposition.

### BRIEF DESCRIPTION OF THE DRAWINGS

The drawings constitute a part of this specification and include exemplary embodiments of the present invention illustrating various objects and features thereof.

FIG. 1 is a schematic diagram of a quantum data buffering system embodying a preferred aspect or embodiment of the present invention.

FIG. 2 is a flowchart showing a quantum data buffering method embodying a preferred aspect or embodiment of the present invention.

FIG. 3 is a flowchart showing the quantum data buffering method.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. Said terminology will include the words specifically mentioned, derivatives thereof and words of similar meaning.

### II. Preferred Embodiment Quantum Data Buffering System 2

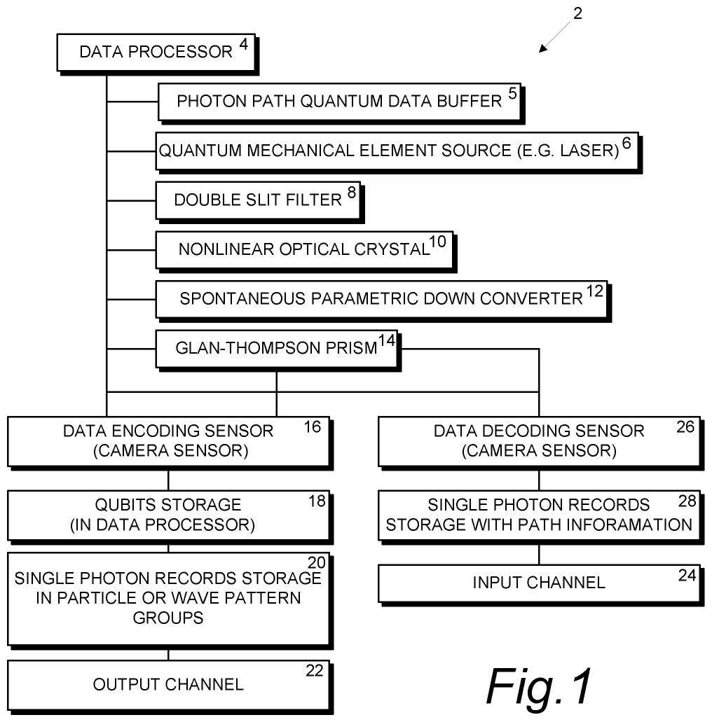

In a preferred photon path-based system 2 embodiment, as shown in FIG. 1, a data processor 4 is connected to a photon path quantum data buffer 5 and a quantum mechanical elements source 6, e.g., a laser with a nonlinear optical crystal 10 and a double slit filter 8. The system 2 can also include a spontaneous parametric down converter 12 and a Glan-Thompson prism 14. Quantum entangled photon pairs are input to a data encoding sensor 16, wherein the pattern can be determined. Quantum entangled photon pair paths are measured by the data decoding sensor 26.

In a preferred photon path-based embodiment, the encoding sensor 16 is a camera sensor capable of detecting individual photons of the entangled pair, which camera sensor records the pattern of photons as waves or particles to encode data in superposition. The decoding sensor 26 can comprise another camera sensor capable of detecting individual photons to determine the path of the photons. This path measurement in combination with observation is used to decode and set the data created from the photon patterns in superposition.

In the preferred photon path-based system 2 embodiment, the data processor 4 is a computer. The data processor 4 takes the data from the encoding sensor 16 and uses pattern recognition to determine if the photons form an interference pattern for a binary 0 or a double line pattern for a binary 1. This binary data is in superposition of 0 and 1 simultaneously, until the combination of measurement and observation collapses the state. After the measurements have been made, the observation is delayed to keep the data in superposition.

The data encoding sensor 16 sends the recorded state of data in superposition to a qubits storage 18 in the data processor 4, where it can be stored indefinitely in an undetermined state, and provides access to a single photon records storage in particle or wave pattern groups 20 forming part of an output channel 22.

An input channel 24 includes a data decoding sensor (e.g., a camera sensor) 26 receiving input from the data processor 4 and connected to a single photon records storage with path information 28. The data decoding sensor 26 sends the measured state of a quantum mechanical element's characteristics to the data processor 4, where it can be stored indefinitely in a determined state.

The data processor 4 takes the data from the data encoding sensorl6 and the data decoding sensor 26 for indefinite storage. The data processor 4 transmits the data in superposition to the output channel 22. The data processor 4 receives the data from the input channel 24 and destroys the measurement information of the data decoding sensor 26, selectively causing the collapse of data in superposition when observed. The selections of measurements to destroy are made by using the data from the input channel 24. Setting a zero destroys a measurement and setting a one retains a measurement to represent binary data, although the scheme could be reversed as long as it is consistent for any data set.

This achieves the instantaneous transfer of information to any location that has received the data in superposition from the quantum data buffer output channel 22. Once the input channel 24 data sets the state of the output channel 22 data, it may be observed.

Observing data from the output channel 22 in superposition prior to it being set by the input channel 24 will collapse the state of the data in superposition to a definite state and prevent the method from transferring state.

### III. Quantum Data Buffering System 2 Applications

The quantum data buffer (QDB) can be used with any digital system. This data stored on that system from a QDB will be in superposition until the time it is observed. This allows for automated systems to work outside of observation and for that work to be determined after the work has completed. Exemplary applications that take advantage of this include:

1) Private, One-Way Communications System

QDBs can be used for digital communications to transfer the data state over any distance instantaneously with no chance of interference or interception. It would also require a communication protocol based on timing to determine when to expose the data to be observed. This is only one way, but it is possible to duplicate that data and distribute it. This does allow for one to many communications similar to multicast, but anyone with the shared buffer data could observe the full buffer data to interfere with the communications. These are some example devices that could use this method: Remote controls (TV, toys, game controllers), Digital content delivery (download first and set the data later), Audio Speakers (No wires), Video displays, Remote sensors, computer mouse/keyboard, and anything that sends a digital signal one way.

2) Private, Two-Way Communication System

QDBs can be used for digital communications to transfer the data state over any distance instantaneously with no chance of interference or interception. Two-way communication would require two separate QDBs. The output data for the two communicators must be exchanged prior to separation. It would also require a communication protocol based on timing to determine when to expose the data to be observed. Because only the two communicating parties have the data to be communicated, it will be private. Devices that could benefit from this include: a pair of walkie-talkies (unlimited range), Earbuds/Headphones, Cable replacements (Any cable that carries a digital signal could be converted to two connectors with QDBs), distributed multiprocessor computing, drones, robotics, secure satellite control, and anything that uses bidirectional digital signals.

3) Trusted Party Communication System

QDBs require that the data be exchanged prior to communication. It would be inconvenient to have to exchange data locally prior to communication. Using a trusted 3rd party allows an exchange of information using an addressing protocol similar to the way a phone number works. All parties that wish to communicate share qubits with the trusted 3rd party. The trusted 3rd party system then acts as a switch board to connect any two buffers for communication. Applications include telecommunications (e g , minimizing dropped calls) and computer networks (digital and quantum with minimal lag).

4) Printing Secure Documents

Documents can be securely printed using qubits from a QDB. Because it is undefined, you can ship it securely. If it is observed before the data is set using the control records then it will be all binary is and reveal nothing. Once it is physically received, but before it is observed, the recipient can signal in a conventional manner that the data can be set. Finally, the documents can be observed with the intended data content.

5) Manufacturing

QDBs can be used to control automated manufacturing. As long as the work is done completely without observation, it can be completed prior to determining the final product. Applications include: finish painting; 3D printing; and other customizable production.

6) Observation Sensor

QDBs produce qubits that are affected by observation. If the qubits are exposed to observation then they take on a definite state. This can be detected by attempting to set a pattern to the data after it has been observed. The attempt will fail exposing the prior observation of the data. Applications include: security systems, computer interfaces, and anything that could use a sensor that detects when it has been observed.

7) Quantum Computing

QDBs produce qubits that are indefinitely stable. This can be used for quantum computing on currently existing computers.

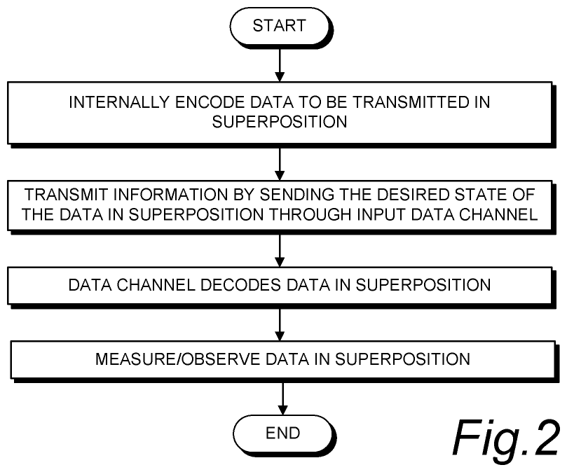

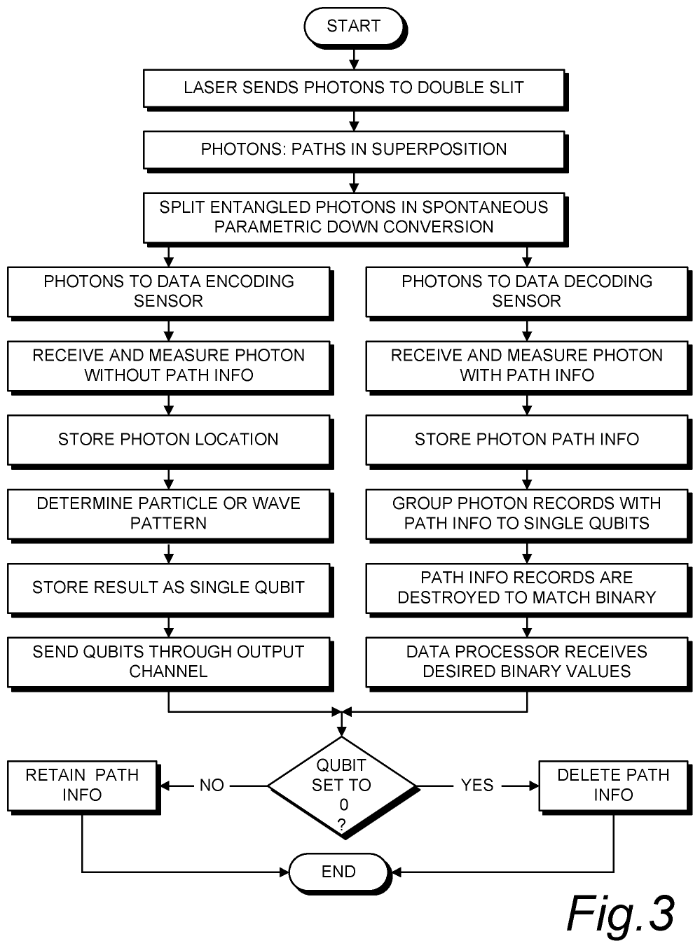

FIG. 2 is a flowchart for a quantum data buffering method embodying an aspect of the present invention. FIG. 3 is another flowchart for a quantum data buffering method embodying an aspect of the present invention.

### CONCLUSION

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A method for quantum data buffering comprising the steps of:
providing a quantum data buffer;
placing quantum mechanical elements in superposition;
encoding data in superposition in said buffer by measurement;
setting the state of said encoded data by controlling the measurement and observation in superposition to a defined state;
providing an external interface with said buffer, said external interface including an output channel of data in superposition and an input channel for setting the state of the data in superposition;
delaying measurement in combination with observation of the data in superposition in said buffer to preserve the data's undetermined state;
achieving information transmission by sending the desired state of the data in superposition through the input data channel; and
decoding the data in superposition.

2. The method according to claim 1, which includes the additional step of:
generating qubits in said quantum data buffer.

3. The method according to claim 1, which includes the additional steps of:
providing a data encoding sensor; and
said data encoding sensor sending the recorded state of data in superposition to the data processor.

4. The method according to claim 3, which includes the additional step of:
storing said data recorded state in superposition in the data processor indefinitely in an undetermined state.

5. The method according to claim 4, which includes the additional steps of:
providing a data decoding sensor; and
said data decoding sensor sending the measured state of a quantum mechanical element characteristic to the data processor.

6. The method according to claim 5, which includes the additional steps of:
storing said measured state in the data processor indefinitely in a determined state.

7. The method according to claim 6, which includes the additional step of:
said data processor transmitting said data in superposition to the output channel.

8. The method according to claim 7, which includes the additional steps of:
said data processor receiving data from the input channel; and
said data processor destroying the measurement information of the data decoding sensor data.

9. The method according to claim 8, which includes the additional step of:
selecting measurements to destroy said data by using the data from the input channel whereby setting a “0” or a “1” destroys a measurement and setting the other of a “0” or a “1” retains a measurement to represent binary data.

10. The method according to claim 9, which includes the additional steps of:
instantaneously transferring information to any location that has received the data in superposition from the quantum data buffers output channel;
setting the state of the output channel data with the input channel data; and
observing the data in superposition.

11. A quantum data buffering system, which includes:
a quantum data buffer;
an encoder configured for encoding data in superposition in said buffer;
said buffer configured for setting the state of said encoded data by controlling the measurement and observation in superposition to a defined state; and
an external interface connected to said buffer and configured for providing an external output of data in superposition.
